(19) United States
(12) Patent Application Publication
(10) Pub. No.: US 2025/0070512 A1
(43) Pub. Date: Feb. 27, 2025

(54) CONNECTOR APPARATUS

(71) Applicant: SUMITOMO WIRING SYSTEMS, LTD., Mie (JP)

(72) Inventor: Harutaka INOUE, Mie (JP)

(21) Appl. No.: 18/797,022

(22) Filed: Aug. 7, 2024

(30) Foreign Application Priority Data
Aug. 22, 2023 (JP) 2023-134410

(51) Int. Cl. H01R 13/639; H01R 13/514; H01R 13/627; H01R 13/641

(52) U.S. Cl. CPC H01R 13/639; H01R 13/514; H01R 13/6272; H01R 13/641

(57) ABSTRACT

A lock arm has a first abutting surface at a position contactable with a lock portion in a fitting process of a first connector and a second connector. The first abutting surface includes a sliding section that extends rearward from a contact start position at which the first abutting surface starts to come into contact with the lock portion, which then slides on the sliding section. The sliding section is inclined relative to a front-rear direction. When the lock portion comes into contact with the first abutting surface at the contact start position in a fitting process of the first connector and the second connector, a first terminal and a second terminal are disposed in a non-contact state.

### CROSS-REFERENCE TO RELATED APPLICATIONS

This application is based on and claims priority from Japanese Patent Application No. 2023-134410, filed on Aug. 22, 2023, with the Japan Patent Office, the disclosure of which is incorporated herein in its entirety by reference.

### TECHNICAL FIELD

The present disclosure relates to a connector apparatus.

### BACKGROUND

A connector disclosed in JP H06-050268 U has a configuration in which, as a result of a protrusion of a flexible arm of a female connector riding over a latch portion of a male connector, the male connector and the female connector are completely fitted to each other. Similarly, a connector disclosed in JP 2006-147291 A has a configuration in which, as a result of a latch portion of a lock arm of a female connector being deflected and riding over a latched portion of a male connector, the male connector and the female connector are completely fitted to each other.

### SUMMARY

Regarding the connector in JP H06-050268 U, in a semi-fitted state in which the latch portion of the male connector and the protrusion of the flexible arm of the female connector start to come into contact with each other, a male terminal and a female terminal can be brought into contact with each other. For this reason, there is a concern that, when an electrical connection between the male terminal and the female terminal is checked even in the semi-fitted state, it may be determined that this connector is in a fitted state due to the male terminal being in electrical conduction with the female terminal. Regarding the connector in JP 2006-147291 A, a portion between a front end and the latch portion of the lock arm is a flat surface extending along the front-rear direction, and there is a concern that a fitting force when the latched portion of the male connector rides over the latch portion of the lock arm will increase.

The present disclosure provides a connector apparatus that can prevent connectors from being left in a semi-fitted state.

A connector apparatus according to the present disclosure includes: a first connector and a second connector that are fittable to each other, the first connector includes a first terminal, a first housing that accommodates the first terminal, and an elastically deformable lock arm formed on the first housing, the second connector includes a second terminal, a second housing that accommodates the second terminal, and a lock portion that is formed on the second housing and to which the lock arm is latched, the lock arm extends in a front-rear direction that is a fitting direction of the first connector and the second connector, and has, at a front end portion of the lock arm, a flexure support portion that is coupled to the first housing, the first terminal and the second terminal are disposed in a contact state and the first connector and the second connector are held in a fitted state when the lock arm is latched to the lock portion, the lock arm has a first abutting surface at a position contactable with the lock portion in a fitting process of the first connector and the second connector, the first abutting surface includes a sliding section that extends rearward from a contact start position at which the first abutting surface starts to come into contact with the lock portion, and on which the lock portion abuts and slides, the sliding section is inclined relative to the front-rear direction, the first terminal and the second terminal are disposed in a non-contact state when the lock portion comes into contact with the first abutting surface at the contact start position in a fitting process of the first connector and the second connector, the lock arm has a second abutting surface contactable with the lock portion, and the second abutting surface is formed rearward of the first abutting surface, and an angle of inclination of the second abutting surface relative to the front-rear direction is larger than that of the first abutting surface.

The present disclosure can provide a connector apparatus that can prevent connectors from being left in a semi-fitted state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector apparatus according to a first embodiment.

FIG. 2 is an exploded perspective view of the connector apparatus according to the first embodiment.

FIG. 3 is a perspective view of a first connector according to the first embodiment.

FIG. 4 is a perspective view of a second connector according to the first embodiment.

FIG. 5 is a side cross-sectional view of the connector apparatus according to the first embodiment when (a lock portion is) positioned at a contact start position.

FIG. 6 is a side cross-sectional view of the connector apparatus when the lock portion is at a position at which the lock portion starts to come into contact with a second abutting surface according to the first embodiment.

FIG. 7 is a side cross-sectional view of the connector apparatus in a fitting-completed state according to the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

Embodiments of the present disclosure will be listed and described below.

(1) A connector apparatus according to the present disclosure includes: a first connector and a second connector that are fittable to each other, the first connector includes a first terminal, a first housing that accommodates the first terminal, and an elastically deformable lock arm formed on the first housing, the second connector includes a second terminal, a second housing that accommodates the second terminal, and a lock portion that is formed on the second housing and to which the lock arm is latched, the lock arm extends in a front-rear direction that is a fitting direction of the first connector and the second connector, and has, at a front end portion of the lock arm, a flexure support portion that is coupled to the first housing, the first terminal and the second terminal are disposed in a contact state and the first connector and the second connector are held in a fitted state when the lock arm is latched to the lock portion, the lock arm has a first abutting surface at a position contactable with the lock portion in a fitting process of the first connector and the second connector, the first abutting surface includes a sliding section that extends rearward from a contact start position at which the first abutting surface starts to come into contact with the lock portion, and on which the lock portion abuts and slides, the sliding section is inclined relative to the front-rear direction, the first terminal and the second terminal are disposed in a non-contact state when the lock portion comes into contact with the first abutting surface at the contact start position in a fitting process of the first connector and the second connector, the lock arm has a second abutting surface contactable with the lock portion, and the second abutting surface is formed rearward of the first abutting surface, and an angle of inclination of the second abutting surface relative to the front-rear direction is larger than that of the first abutting surface.

With the configuration in the above (1), when the lock portion comes into contact with the first abutting surface at the contact start position in the fitting process of the first connector and the second connector, the first terminal and the second terminal are disposed in a non-contact state. For this reason, when the lock portion is in contact with the first abutting surface at the contact start position, the first terminal and second terminal are not electrically connected to each other, and it is possible to ascertain a semi-fitted state of the first connector and the second connector by conducting an electrical connection check. In this state, the sliding section of the first abutting surface is inclined relative to the front-rear direction, and thus it is possible to reduce a force required for a fitting operation by bending the lock arm at a relatively early stage in the fitting process. In addition, the lock arm has the second abutting surface that is inclined relative to the front-rear direction at a larger angle than the first abutting surface. For this reason, when the lock portion moves past the second abutting surface, the first connecter and the second connector are likely to be fitted to each other instantly without stopping halfway, and to be completely fitted to each other. Particularly, the second abutting surface is at a position that is more distant from the flexure support portion than the first abutting surface, which makes it easy to reduce an insertion force when the lock portion moves past the second abutting surface. Therefore, the connector apparatus can prevent the first connector and the second connector from being left in the semi-fitted state.

(2) In the connector apparatus according to the above (1), preferably, the lock arm has a straight surface that extends along the front-rear direction, between the first abutting surface and the second abutting surface.

With the configuration in the above (2), it is possible to reduce the degree of elastic deformation of the lock arm when the lock portion comes into contact with the straight surface relative to an inclined surface. For this reason, the lock portion easily opposes the second abutting surface that is rearward of the straight surface, and when fitting of the connectors progresses, the lock portion easily abuts on the second abutting surface and presses the second abutting surface in.

(3) In the connector apparatus according to the above (1) or (2), preferably, the first terminal is a female terminal, the second terminal is a male terminal, the first housing has a front wall capable of abutting on and stopping the first terminal, a through hole into which the second terminal is to be inserted is provided in the front wall, and when the lock portion comes into contact with the first abutting surface at the contact start position, the first terminal and the second terminal are spaced apart from each other by the through hole of the front wall.

With the configuration in the above (3), the first terminal and the second terminal are spaced apart from each other by the front wall, and thus the first terminal and the second terminal can be reliably separated from each other.

(4) In the connector apparatus according to any one of the above (1) to (3), preferably, while the lock portion is sliding on the sliding section, the first terminal and the second terminal are disposed in a non-contact state.

With the configuration in the above (4), in the fitting process of the first connector and the second connector, the first terminal and the second terminal can be brought into contact with each other in a state that is closer to a fitting-completed state.

### Details of Embodiments of the Present Disclosure

Embodiments of the present disclosure will be described below with reference to the drawings. Note that the present disclosure is not limited to these examples, but rather is indicated by the claims, and includes all modifications that are within the meanings and the scope that are equivalent to those of the claims.

### First Embodiment

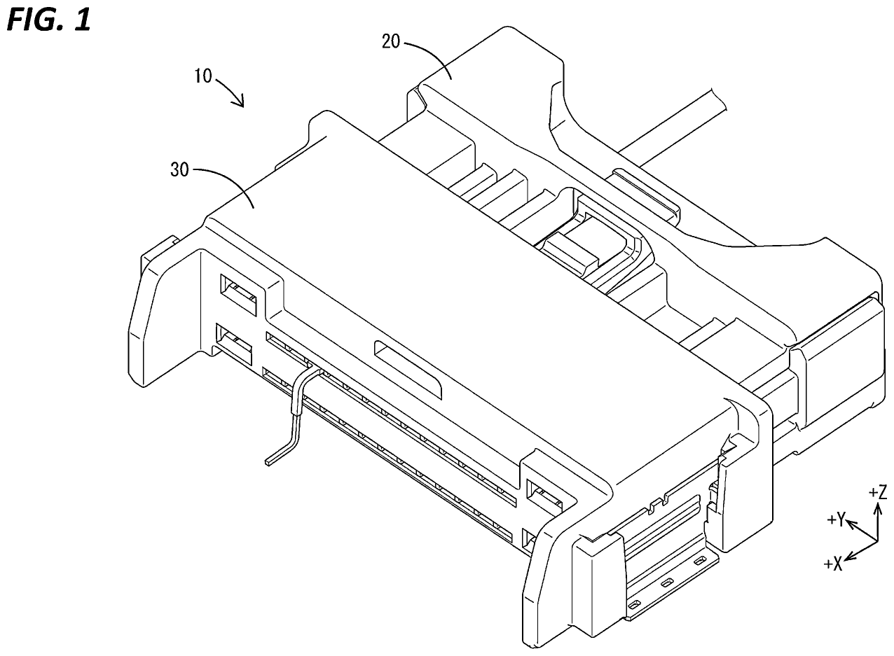

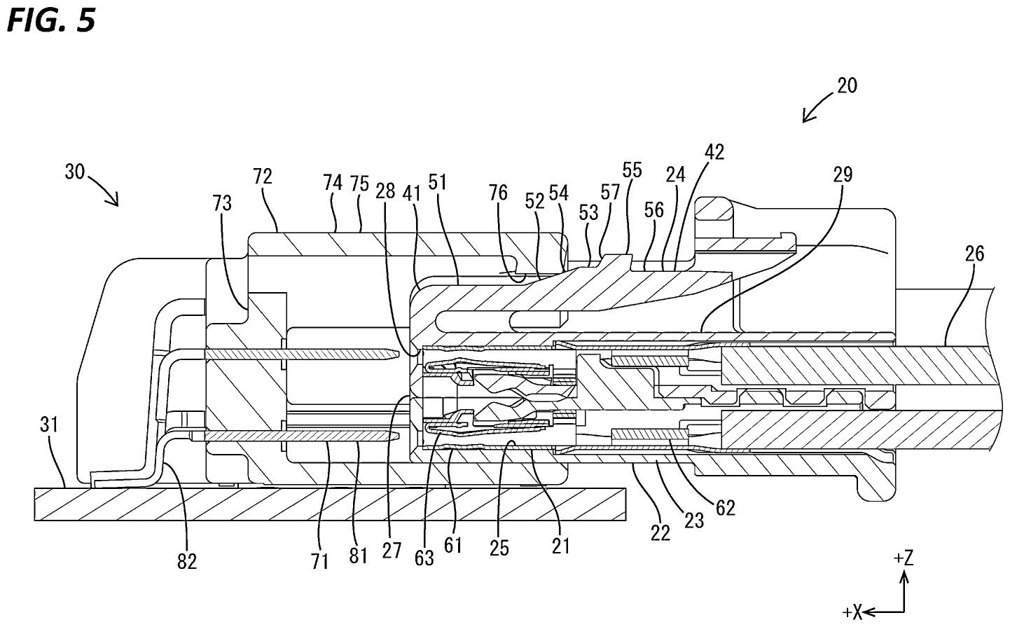

A connector apparatus 10 according to a first embodiment includes a first connector 20 and a second connector 30 that are fittable to each other. The fitting direction of the connectors 20 and 30 is a front-rear direction. In the first embodiment, regarding the front-rear direction, the positive direction side of the X axis in FIGS. 1 and 5 is defined as a front side. Regarding the up-down direction, the positive direction side of the Z axis in FIGS. 1 and 5 is defined as an upward side. Regarding the left-right direction, the positive direction side of the Y axis in FIG. 1 is defined as a right side.

### (First Connector 20)

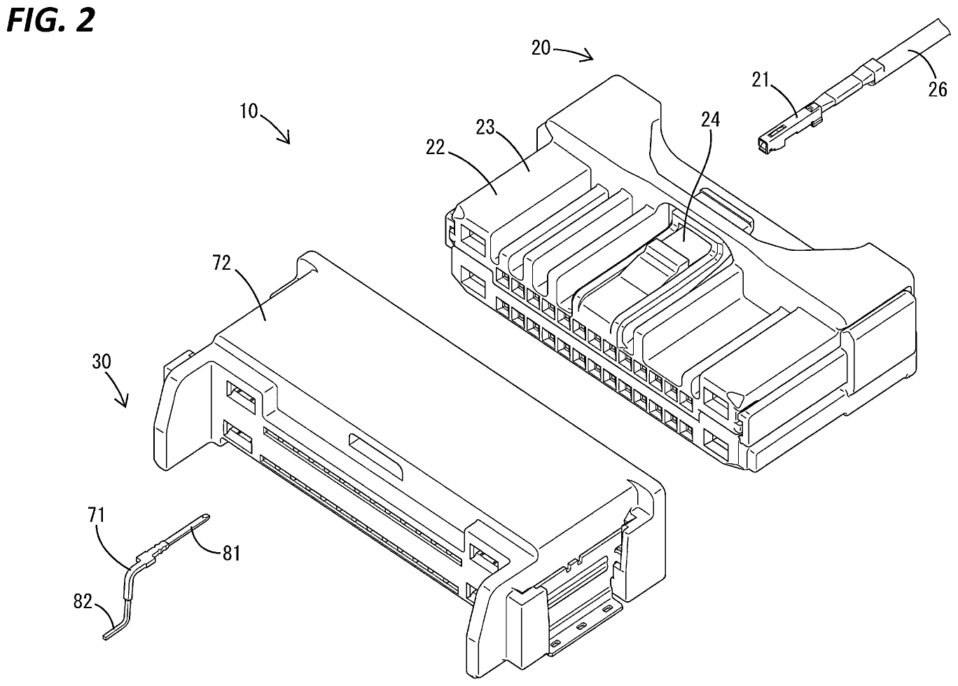

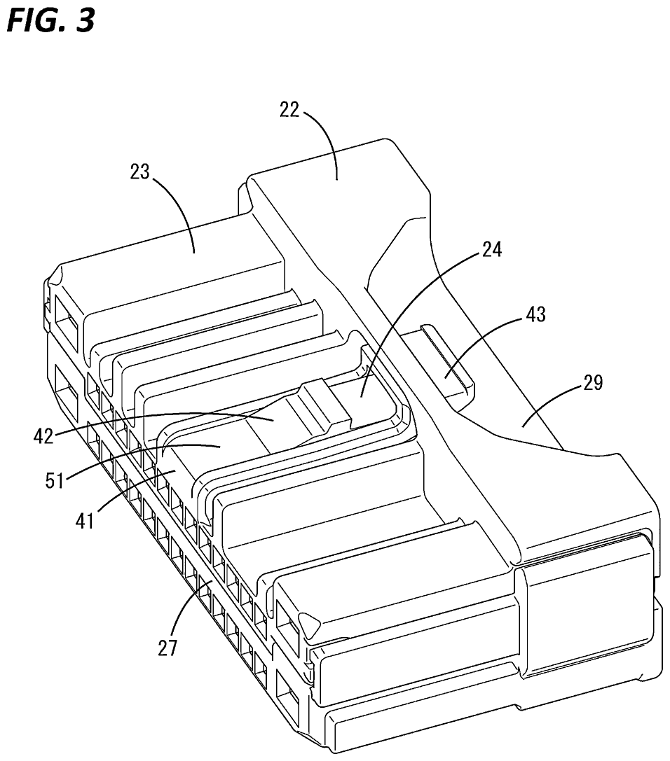

The first connector 20 is a female connector as shown in FIG. 2. The first connector 20 includes a first terminal 21 and the first housing 22. The first housing 22 is a female housing. The first housing 22 is made of a synthetic resin. The first housing 22 accommodates the first terminal 21. The first housing 22 is a single component having a flattened shape. The first housing 22 includes a housing main body portion 23 and a lock arm 24 as shown in FIG. 3.

The housing main body portion 23 has an overall flattened rectangular parallelepiped shape. As shown in FIG. 5, a plurality of terminal accommodation chambers 25 that pass through the housing main body portion 23 in the front-rear direction are formed in the housing main body portion 23. The terminal accommodation chambers 25 are arranged at a fixed pitch in the left-right direction in two levels, namely upper and lower levels. The first terminal 21 firmly fixed to a front end portion of an electric wire 26 is inserted into one of the terminal accommodation chambers 25.

As shown in FIG. 5, a front wall 27 is provided on the housing main body portion 23. The front wall 27 forms a wall on the front side of the plurality of terminal accommodation chambers 25. The first terminal 21 can abut on the front wall 27 and is stopped. Through holes 28 corresponding to the terminal accommodation chambers 25 are formed in the front wall 27. A second terminal 71 is inserted into a terminal accommodation chamber 25 through the through hole 28.

As shown in FIG. 3, the lock arm 24 is disposed at a central portion in the left-right direction of the first housing 22. The lock arm 24 extends in the front-rear direction. The lock arm 24 is elastically deformable in the up-down direction. The lock arm 24 includes a flexure support portion 41, an arm main body portion 42, and an operating portion 43.

As shown in FIG. 5, the flexure support portion 41 forms a front end portion of the lock arm 24, and is coupled to a front end portion of an outer wall surface (upper surface) 29 of the housing main body portion 23. The arm main body portion 42 has a flat plate-like shape elongated in the front-rear direction. The arm main body portion 42 extends rearward in a cantilever fashion from the flexure support portion 41 along the outer wall surface 29 of the housing main body portion 23. The operating portion 43 protrudes rearward and upward from a rear end of the arm main body portion 42. The operating portion 43 is a portion for performing a pressing operation on the lock arm 24 to unlock the lock arm 24.

As shown in FIG. 5, a front-side upper surface 51, a first abutting surface 52, and a straight surface 53 are provided on the upper surface of the arm main body portion 42. The front-side upper surface 51 forms a front-end-side portion of the upper surface of the arm main body portion 42. The front-side upper surface 51 is a flat surface extending along the front-rear direction in a state where the lock arm 24 does not elastically deform.

The first abutting surface 52 is continuous to the rearside of the front-side upper surface 51. The first abutting surface 52 is provided at a position contactable with a lock portion 76 of a second housing 72 to be described later, in a fitting process of the first connector 20 and the second connector 30. The first abutting surface 52 is inclined upward relative to the front-rear direction toward the rear.

The first abutting surface 52 includes a sliding section 54 that extends rearward from a contact start position at which the first abutting surface 52 starts to come into contact with the lock portion 76 of the second housing 72 to be described later, and on which the lock portion 76 slides. The sliding section 54 forms a rear-end-side portion of the first abutting surface 52. The sliding section 54 is inclined upward relative to the front-rear direction toward the rear.

The straight surface 53 is continuous to the rearside of the first abutting surface 52. The straight surface 53 is provided between the first abutting surface 52 and a second abutting surface 57 to be described later. The straight surface 53 is a flat surface extending along the front-rear direction in a state where the lock arm 24 does not elastically deform.

As shown in FIG. 5, a protrusion portion 55 and a rear-side upper surface 56 are provided on the upper surface of the arm main body portion 42. The protrusion portion 55 protrudes upward from a position rearward of the straight surface 53. The protrusion portion 55 has a rectangular shape in planar view. The second abutting surface 57 is provided in front of the protrusion portion 55.

The second abutting surface 57 is formed rearward of the first abutting surface 52. The second abutting surface 57 is continuous to the rearside of the straight surface 53. The second abutting surface 57 is inclined upward toward the rear. The angle of inclination of the second abutting surface 57 relative to the front-rear direction is larger than the angle of inclination of the first abutting surface 52 relative to the front-rear direction. The angle of inclination of the second abutting surface 57 relative to the front-rear direction (horizontal direction) is an angle close to the right angle. Here, the angle of inclination of the second abutting surface 57 relative to the front-rear direction is an angle formed by a straight line parallel to the front-rear direction and the second abutting surface 57 and is the minor angle. Similarly, the angle of inclination of the first abutting surface 52 relative to the front-rear direction is also an angle formed by a straight line parallel to the front-rear direction and the second abutting surface 57 and is the minor angle.

The rear-side upper surface 56 is continuous to the rearside of the protrusion portion 55. The rear-side upper surface 56 is a flat surface extending along the front-rear direction in a state where the lock arm 24 does not elastically deform.

The first terminal 21 is a female terminal as shown in FIG. 2. The first terminal 21 is integrally formed by punching an electrically conductive metal plate into a predetermined shape, and performing a bending process and the like. As shown in FIG. 5, the first terminal 21 includes a main body portion 61, an elastic contact portion 62, and a crimping portion 63. The main body portion 61 has a square tubular shape. A second terminal 71 is inserted into the main body portion 61. The elastic contact portion 62 is disposed in the main body portion 61. The elastic contact portion 62 extends rearward from the front end of the main body portion 61. The crimping portion 63 is firmly fixed to the front end portion of the electric wire 26.

### (Second Connector 30)

As shown in FIG. 2, the second connector 30 is a male connector. The second connector 30 functions as a substrate connector that is mounted on a circuit substrate 31 (see FIG. 5). The second connector 30 includes the second terminal 71 and the second housing 72.

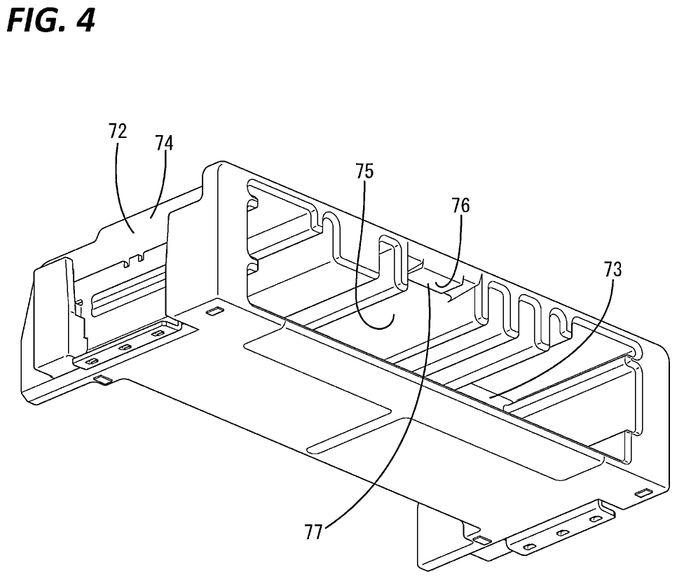

The second housing 72 is a male housing. The second housing 72 is made of a synthetic resin. The second housing 72 holds the second terminal 71. As shown in FIG. 4, the second housing 72 is a single component having a flattened shape. The second housing 72 includes a terminal holding portion 73 and a hood portion 74. The terminal holding portion 73 has a wall-like shape. As shown in FIG. 5, the terminal holding portion 73 holds a plurality of second terminals 71. The hood portion 74 protrudes rearward (to the first connector 20 side) from the outer peripheral edge of the terminal holding portion 73 and has a flattened square tubular shape.

As shown in FIG. 4, the lock portion 76 is provided on the inner surface (lower surface) of an upper wall portion 75 that forms the hood portion 74. The lock arm 24 of the first housing 22 is latched to the lock portion 76. The lock portion 76 protrudes downward from the inner surface of the upper wall portion 75. The lock portion 76 has a rectangular shape as viewed from below.

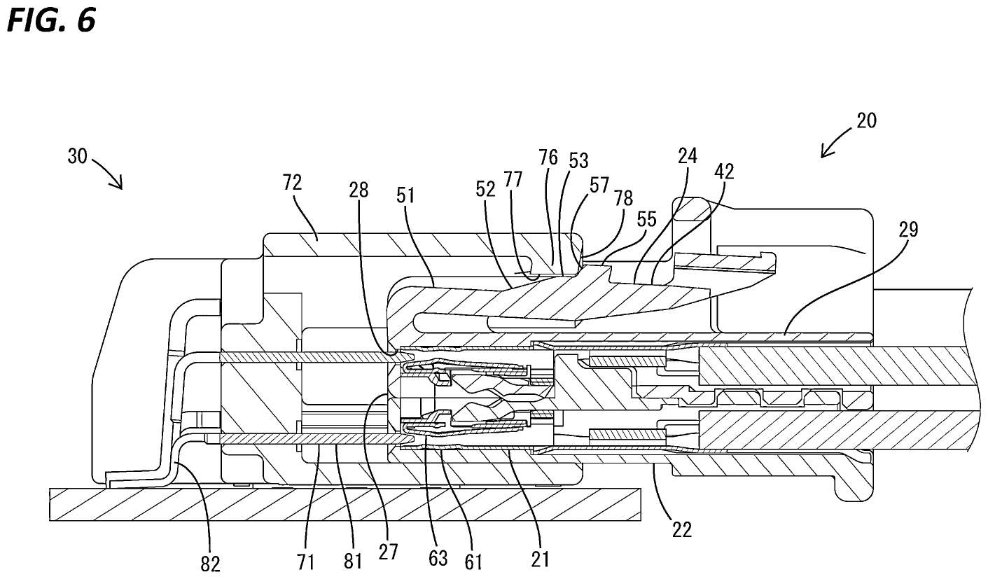

As shown in FIG. 6, a lower surface 77 of the lock portion 76 is a flat surface extending along the front-rear direction. A rear surface 78 of the lock portion 76 is inclined upward relative to the front-rear direction toward the rear.

Each second terminal 71 is formed by punching a plate material into a bar and bending the bar. The second terminal 71 includes a terminal connection portion 81 and a substrate connection portion 82. The terminal connection portion 81 extends in the front-rear direction. As shown in FIG. 5, the terminal connection portion 81 is press-fit into the terminal holding portion 73. A tab of a leading end portion of the terminal connection portion 81 is disposed in the hood portion 74. The substrate connection portion 82 is bent in an L-shape. The substrate connection portion 82 extends downward from a base end of the terminal connection portion 81, outside of the second housing 72 (the hood portion 74). The substrate connection portion 82 is connected to the circuit substrate 31.

### (Fitting of Connectors 20 and 30)

When the first connector 20 and the second connector 30 are fitted to each other, the first housing 22 is brought into the hood portion 74 of the second housing 72. In the fitting process of the first connector 20 and the second connector 30, as shown in FIG. 5, the lock portion 76 comes into contact with the first abutting surface 52 at the contact start position. When the lock portion 76 is at the contact start position, the first terminal 21 and the second terminal 71 are disposed in a non-contact state. Specifically, the first terminal 21 and the second terminal 71 are disposed spaced apart from each other without entering the through hole 28 of the front wall 27.

Furthermore, as fitting of the first connector 20 and the second connector 30 progresses, the lock portion 76 slides on the sliding section 54 of the first abutting surface 52. The sliding section 54 is inclined upward toward the rear, and thus, as fitting of the first connector 20 and the second connector 30 progresses, the lock arm 24 elastically deforms so as to approach the outer wall surface 29 of the first housing 22. Also while the lower surface of the lock portion 76 is sliding on the sliding section 54, the first terminal 21 and the second terminal 71 are in a non-contact state.

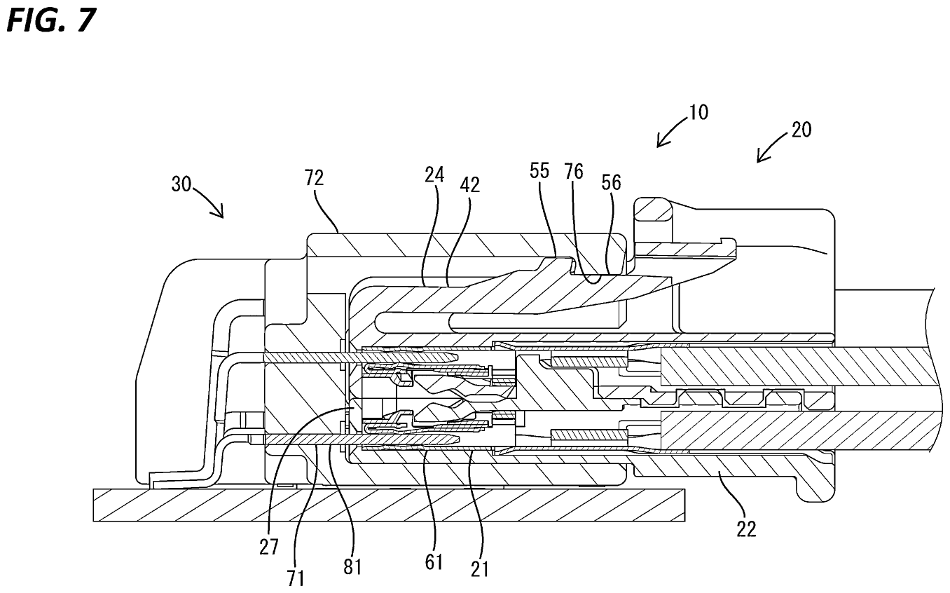

When fitting of the first connector 20 and the second connector 30 further progresses, the lock portion 76 comes into contact with the straight surface 53. When fitting of the first connector 20 and the second connector 30 further progresses, the lock portion 76 comes into contact with the second abutting surface 57 as shown in FIG. 6. When the lock portion 76 moves past the protrusion portion 55 of the lock arm 24, the first connector 20 and the second connector 30 enter a proper fitted state (see FIG. 7) instantly due to elasticity. The inclination angle of the second abutting surface 57 is larger than the inclination angle of the first abutting surface 52, and when the lock portion 76 moves past the second abutting surface 57, the first connector 20 and the second connector 30 are likely to enter the proper fitted state (see FIG. 7) instantly without stopping fitting.

As shown in FIG. 7, in a state where the protrusion portion 55 of the lock arm 24 is latched to the lock portion 76, the first connector 20 and the second connector 30 are held in a fitted state, and enter the proper fitted state.

### Effects of Connector Apparatus 10 According to First Embodiment

In the connector apparatus 10 according to the first embodiment, when the lock portion 76 comes into contact with the first abutting surface 52 at the contact start position in a fitting process of the first connector 20 and the second connector 30, the first terminal 21 and the second terminal 71 are disposed in the non-contact state. For this reason, when the lock portion 76 is in contact with the first abutting surface 52 at the contact start position, the first terminal 21 and the second terminal 71 are not electrically connected, and it is possible to ascertain a semi-fitted state of the first connector 20 and the second connector 30 by conducting an electrical connection check. In this state, since the sliding section 54 of the first abutting surface 52 is inclined relative to the front-rear direction, and thus it is possible to bend the lock arm 24 and reduce a force required for a fitting operation at a relatively early stage in the fitting process. In addition, the lock arm 24 has the second abutting surface 57 that is inclined relative to the front-rear direction at a larger angle than the first abutting surface 52. For this reason, when the lock portion 76 moves past the second abutting surface 57, the first connector 20 and the second connector 30 are easily fitted to each other instantly without stopping halfway, and the fitting therebetween can be easily completed. Particularly, the second abutting surface 57 is at a position more distant from the flexure support portion 41 than the first abutting surface 52, and the lock portion 76 is likely to be displaced when moving past the second abutting surface 57, thus making it easy to reduce an insertion force. Therefore, the connector apparatus 10 can prevent the first connector 20 and the second connector 30 from being left in the semi-fitted state.

In the connector apparatus 10 according to the first embodiment, the lock arm 24 has the straight surface 53 extending along the front-rear direction between the first abutting surface 52 and the second abutting surface 57. With such a configuration, when the lock portion 76 comes into contact with the straight surface 53, it is possible to reduce the degree of elastic deformation of the lock arm 24. For this reason, the lock portion 76 easily opposes the second abutting surface 57 rearward of the straight surface 53, and the lock portion 76 easily abuts on the second abutting surface 57 and presses the second abutting surface 57 in when fitting of the connectors 20 and 30 progresses.

In the connector apparatus 10 according to the first embodiment, the first housing 22 has the front wall 27 capable of abutting on and stopping the first terminal 21. When the lock portion 76 comes into contact with the first abutting surface 52 at the contact start position, the first terminal 21 and the second terminal 71 are disposed spaced apart from each other by the through hole 28 of the front wall 27. With such a configuration, when the lock portion 76 comes into contact with the first abutting surface 52 at the contact start position, the first terminal 21 and the second terminal 71 can be reliably spaced apart from each other.

In the connector apparatus 10 according to the first embodiment, while the lock portion 76 is sliding on the sliding section 54, the first terminal 21 and the second terminal 71 are disposed in the non-contact state. With such a configuration, in the fitting process of the first connector 20 and the second connector 30, the first terminal 21 and the second terminal 71 can be brought into contact with each other in a state that is closer to a fitting-completed state. For this reason, it is easy to prevent the connector apparatus 10 in the semi-fitted state from being determined as being in the proper fitted state based on an electric connection check on the first terminal 21 and the second terminal 71.

### Other Embodiment

The present invention is not limited to the first embodiment described in the description above and the drawings, and is defined by the scope of the claims. All changes that fall within the same essential spirit as the scope of the claims are included in the present invention, and the following embodiments are also intended to be included therein.

In the first embodiment above, the angle of inclination of the second abutting surface 57 relative to the front-rear direction is an angle close to the right angle, but may be the right angle.

In the first embodiment above, in the first housing 22, the terminal accommodation chambers 25 are arranged in two levels, namely an upper level and a lower level, but may be arranged in a single level or three or more vertical levels.

In the first embodiment above, the first connector 20 is configured as a female connector and the second connector 30 is configured as a male connector, but a configuration may also be adopted in which the first connector 20 is configured as a male connector and the second connector 30 is configured as a female connector.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector apparatus comprising:
a first connector and a second connector that are fittable to each other,
wherein the first connector includes a first terminal, a first housing that accommodates the first terminal, and an elastically deformable lock arm formed on the first housing,
the second connector includes a second terminal, a second housing that accommodates the second terminal, and a lock portion formed on the second housing and to which the lock arm is locked,
the lock arm extends in a front-rear direction that is a fitting direction of the first connector and the second connector, and has, at a front end portion of the lock arm, a flexure support portion that is coupled to the first housing,
the first terminal and the second terminal are disposed in a contact state and the first connector and the second connector are held in a fitted state when the lock arm is latched to the lock portion,
the lock arm has a first abutting surface at a position contactable with the lock portion in a fitting process of the first connector and the second connector,
the first abutting surface includes a sliding section that extends rearward from a contact start position at which the first abutting surface starts to come into contact with the lock portion, and on which the lock portion abuts and slides,
the sliding section is inclined relative to the front-rear direction,
the first terminal and the second terminal are disposed in a non-contact state when the lock portion comes into contact with the first abutting surface at the contact start position in a fitting process of the first connector and the second connector,
the lock arm has a second abutting surface contactable with the lock portion, and
the second abutting surface is formed rearward of the first abutting surface, and an angle of inclination of the second abutting surface relative to the front-rear direction is larger than that of the first abutting surface.

2. The connector apparatus according to claim 1,
wherein the lock arm has a straight surface that extends along the front-rear direction, between the first abutting surface and the second abutting surface.

3. The connector apparatus according to claim 1,
wherein the first terminal is a female terminal,
the second terminal is a male terminal,
the first housing has a front wall capable of abutting on and stopping the first terminal,
a through hole into which the second terminal is to be inserted is provided in the front wall, and
when the lock portion comes into contact with the first abutting surface at the contact start position, the first terminal and the second terminal are spaced apart from each other by the through hole of the front wall.

4. The connector apparatus according to claim 1,
wherein, while the lock portion is sliding on the sliding section, the first terminal and the second terminal are disposed in a non-contact state.
